(19) United States
(12) Patent Application Publication
(10) Pub. No.: US 2024/0013179 A1
(43) Pub. Date: Jan. 11, 2024

(54) SYSTEMS AND METHODS TO DETERMINE CONTENT FOR A NARRATIVE BASED ON USER INPUT RELATED TO THE NARRATIVE

(71) Applicant: Disney Enterprises, Inc., Burbank, CA (US)

(72) Inventors: Alif Khalfan, Redwood City, CA (US); Brianna Cochran, Los Angeles, CA (US); Zachary Shalett, Los Angeles, CA (US); Benjamin Lopez Barba, Rancho Cucamonga, CA (US); Malcolm E. Murdock, Burbank, CA (US)

(21) Appl. No.: 18/348,569

(22) Filed: Jul. 7, 2023

Related U.S. Application Data
(60) Provisional application No. 63/359,156, filed on Jul. 7, 2022.

(51) Int. Cl. G06Q 20/12; G06Q 20/36

(52) U.S. Cl. CPC G06Q 20/1235; G06Q 20/36

(57) ABSTRACT

Systems and methods to determine content for a narrative based on user input related to the narrative are disclosed. Exemplary implementations may: effectuate presentation of a narrative via client computing platforms associated with users; obtain, user inputs in relation to the active content; initiate a smart contract configured to receive the user inputs; initiate a smart contract configured to determine whether the user inputs include one or more of the trigger events; initiate a smart contract configured to determine the inactive content for presentation upon determination that one or more of the trigger events occurred; initiate a smart contract configured to transmit an indication to the one or more processors to effectuate presentation of the inactive content; and initiate a smart contract configured to generate and execute a set of instructions to record the reclassification and the active content on the decentralized ledger.

### CROSS-REFERENCE TO RELATED APPLICATIONS

The present application claims priority benefit of the U.S. Provisional Patent Application No. 63/359,156 titled “SYSTEMS AND METHODS TO DETERMINE CONTENT FOR A STORY BASED ON USER INPUT RELATED TO THE NARRATIVE” filed on Jul. 7, 2022, the contents of which are incorporated herein by reference in their entirety. The subject matter of this related application is hereby incorporated herein by reference.

### FIELD OF THE DISCLOSURE

The present disclosure relates to systems and methods to determine content for a narrative based on user input related to the narrative.

### BACKGROUND

Experiences where a user is enabled to customize a narrative or book as they proceed may be costly to implement such an experience for a plurality of users.

### SUMMARY

One aspect of the present disclosure relates to a system configured to determine content for a narrative based on user input related to the narrative. The narrative may be an interactive experience. Limited portions of the narrative may be presented to users via client computing platforms. The narrative may present or make available content that is classified as active content. As the users progress through the narrative, they may discover more active content. Based on how the users interact with the active content or responsive to discovering one or more of the active content, a smart contract may determine whether such user interactions satisfy one or more trigger events that are associated with inactive content stored in electronic storage. Responsive to satisfaction of the one or more trigger events, the associated inactive content may be determined and transmitted to servers (the same that effectuate presentation of the narrative) for presentation. The classification of the inactive content and the action content may be updated accordingly and recorded on a decentralized ledger. Thus, a unique narrative may be generated based on multiple users' input where the narrative may be viewed and immutable upon completion.

The system may include one or more hardware processors configured by machine-readable instructions. The machine-readable instructions may include one or more instruction components. The instruction components may include computer program components. The instruction components may include one or more of a presentation effectuation component, a user input obtaining component, a contract initiation component, and/or other instruction components.

The presentation effectuation component may be configured to effectuate presentation of a narrative via client computing platforms associated with users. The narrative may be stored in electronic storage. The narrative may include content that is classified as active content and inactive content. The active content may be presented and available as the narrative progresses. The inactive content may be available within the narrative upon trigger events associated with the inactive content occurring. The active content within the narrative may be recorded on a decentralized ledger.

The user input obtaining component may be configured to obtain, in an ongoing manner, via the client computing platforms, user inputs in relation to the active content.

The contract initiation component may be configured to initiate a smart contract configured to, in an ongoing manner, receive the user inputs, determine whether the user inputs include one or more of the trigger events, determine the inactive content for presentation upon determination that one or more of the trigger events occurred, transmit an indication to the one or more processors to effectuate presentation of the inactive content. Effectuating presentation of the inactive content may reclassify the inactive content as the active content. The smart contract may be further configured to generate and execute a set of instructions to record the reclassification and the active content on the decentralized ledger, and/or other functionalities.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to determine content for a narrative based on user input related to the narrative, in accordance with one or more implementations.

FIG. 2 illustrates a method to determine content for a narrative based on user input related to the narrative, in accordance with one or more implementations.

FIGS. 3A-B illustrate an example implementation of the system configured to determine content for a narrative based on user input related to the narrative, in accordance with one or more implementations.

### DETAILED DESCRIPTION

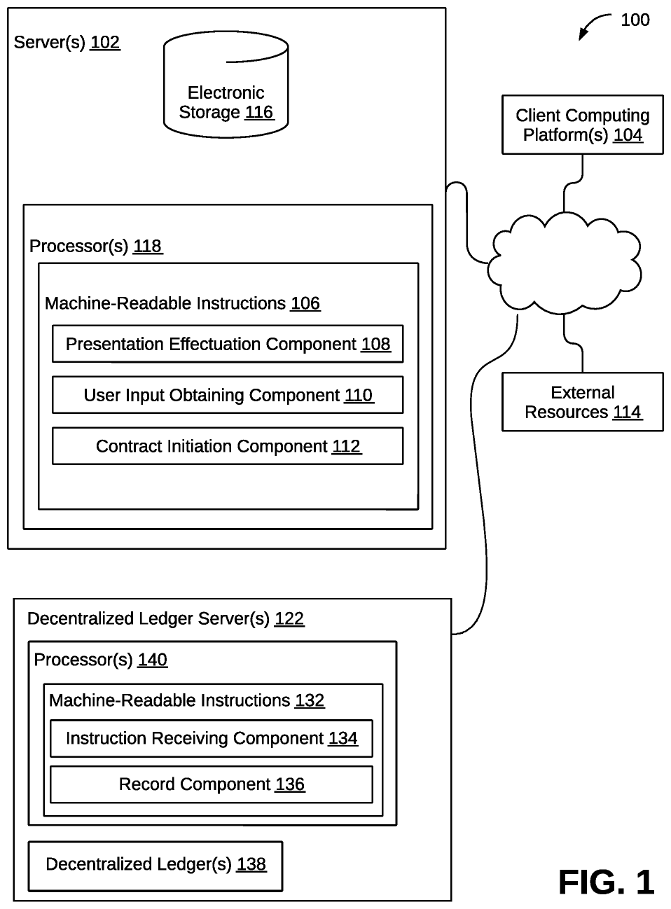

FIG. 1 illustrates a system 100 configured to determine content for a narrative based on user input related to the narrative, in accordance with one or more implementations. In some implementations, system 100 may include one or more servers 102, electronic storage 116, and/or other elements. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Electronic storage 116 may be configured to store a narrative and/or other information. The narrative may be related to particular topics and/or genres. The narrative may include content that is classified as active content or inactive content. The content may include one or more of a description, a visual content item, an audible content item, haptic content, and/or other content. In some implementations, the narrative may be virtually interactive, and therefore, the content may include virtual items within a virtual setting that the user or a character representing the user may move and/or progress through. By way of non-limiting example, the virtual items may include buildings, trees, bushes, rocks, vehicles, furniture, tools, toys, amongst others. The user or the character may interact with the virtual items and/or the virtual setting. The user interactions may include displacing, modifying, touching, rotating, hiding amongst one or more of the virtual content items within the virtual setting, and/or other user interactions. The active content may be presented and available as the narrative progresses. That is, user input from the users is not required to access the active content within the narrative.

The active content within the narrative may be recorded on a decentralized ledger. As such, the active content may be immutable. The inactive content may be available within the narrative or made available within the narrative upon trigger events associated with the inactive content occurring. The trigger events may include receiving particular user input, receiving a specific amount of the particular user input, receiving a specific amount of any user input, a lapse of a particular amount of time, occurrence of one or more real world events, and/or other trigger events. The user input may include, by way of non-limiting example, the user interactions by the users with the active content, answers to the active content that are or include questions/inquires, emphasizing or noting particular active content, and/or other user inputs. Indications of the occurrence of the one or more real world events may be received from external resources 114 such as sports coverage platforms, weather tracking platforms, political result platforms, and/or other external resources.

In some implementations, the narrative may include checkpoints. The checkpoints may be points within the narrative where a plot point may begin, where another plot point may end, and/or indicate other information within the narrative. In some implementations, the active content may progress towards individual ones of the checkpoints.

In some implementations, the content may include tiers for the inactive content. By way of non-limiting example, the tiers may include a first tier, a second tier, a third tier, and/or other tiers as an order of accessibility of the inactive content by way of the trigger events associated with the inactive content. That is, the different tiers may correspond to different levels of difficulty to access the inactive content. For example, the inactive content in the first tier may be associated with trigger events that require a user interaction or user answer as the user inputs. The user interaction or user answer may be any user interaction or answer, and not specific. As another example, the inactive content in the second tier may be associated with trigger events that require multiple ones of the user inputs. As another example, the inactive content in the third tier may be associated with trigger events that require multiple and particular ones of the user inputs.

Server(s) 102 may be configured by machine-readable instructions 106. Machine-readable instructions 106 may include one or more instruction components. The instruction components may include computer program components. The instruction components may include one or more of presentation effectuation component 108, user input obtaining component 110, contract initiation component 112, and/or other instruction components.

Presentation effectuation component 108 may be configured to effectuate presentation of the narrative via client computing platforms 104 associated with users. The presented portions of the narrative may include the active content. In some implementations, an initial presentation of the narrative may be the same for all users. In some implementations, the narrative may be a cumulation of all the user inputs of all the users. Thus, as the user inputs are obtained and the inactive content is presented and reclassified as active content, the narrative may be different upon the users' re-access. In some implementations, the narrative may not be cumulative but specific to each user. That is, the narrative may change for each user as each user progresses through their own narrative and provide their user inputs. Thus, each user experiences and causes changes to create a different narrative from others.

User input obtaining component 110 may be configured to obtain via client computing platforms 104, the user inputs in relation to the active content. The user input may be obtained in an ongoing manner. The term “ongoing manner” as used herein may refer to continuing to perform an action (e.g., obtain) periodically (e.g., every 30 seconds, every minute, every hour, etc.) until receipt of an indication to terminate. The indication to terminate may include powering off client computing platform 104, charging one or more of a battery of client computing platform 104, resetting client computing platform 104, minimizing or closing the presentation of the narrative, and/or other indications of termination. The active content presented as the narrative may solicit or request for the user input.

Contract initiation component 112 may be configured to initiate a smart contract. The smart contract may include an executable code or program capable of receiving inputs, making determinations, and/or providing outputs via specified functionalities. The smart contract may be configured to execute the functionalities in an ongoing manner. The ongoing manner of execution of the functionalities of the smart contract may mean that the smart contract re-initiates once the smart contract has executed all the functionalities. The re-initiation in the ongoing manner may occur every ten minutes, every hour, and/or at other points in time.

The smart contract may be configured to receive the user inputs. The smart contract may be configured to determine whether the user inputs satisfy one or more of the trigger events. Thus, the smart contract may determine whether one or more of the inactive content is to be presented in the narrative and reclassified as the active content. The smart contract may be configured to determine the inactive content for presentation upon determination that one or more of the trigger events associated with the inactive content occurred. The smart contract may be configured to transmit an indication to sever(s) 102, particularly presentation effectuation component 108, to effectuate presentation of the inactive content. In some implementations, the inactive content may be situated at particular points during the narrative as opposed to being added to extend the narrative. As such, upon the users re-accessing portions of the narrative or upon other users progressing through the narrative, newly active content may be presented and available. In some implementations, the inactive content may be added to the end of the narrative to extend the narrative. Effectuating presentation of the inactive content may reclassify the inactive content as the active content. The smart contract may be configured to generate and execute a set of instructions to record the reclassification and the active content on decentralized ledger 138. Sets of instructions generated by the smart contract may be transmitted to an instruction receiving component 134 described herein. Subsequently, a record component 136 described herein may record the sets of instructions on decentralized ledger 138.

The reclassification and the recording the active content on decentralized ledger 138 may signify that the active content cannot be reverted back to inactive content. Thus, other users may access the active content at those particular points during their progression through the narrative given they have not reached those points yet or during re-access of the narrative at those points. In some implementations, the active content may uncover or facilitate with uncovering other inactive content.

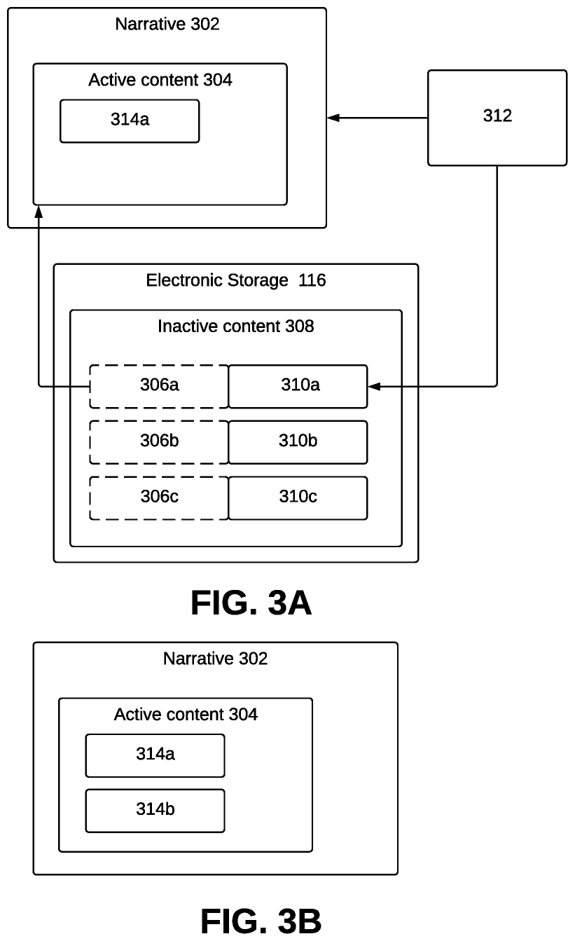

FIG. 3A illustrates a narrative 302 that presents active content 304. Active content 304 may include content 314a that users may consume and interact with to progress narrative 302. Electronic storage 116 (the same as in FIG. 1) may store content 306a, 306b, and 306c that are classified as inactive content 308 in relation to narrative 302. That is, content 306a-c are not currently presented or available for interaction in narrative 302 by the users. Each of content 306a-c may be associated with a trigger event 310a, 310b, and 310c, respectively. Upon receipt of user input 312 by the users in relation to narrative 302, it may be determined whether use input 312 satisfies one or more of trigger events 310a-c. Upon trigger event 310a being satisfied, associated content 306a may be reclassified as active content 304. Thus, FIG. 3B illustrates narrative 302 (the same as in FIG. 3A) where narrative 302 presents or makes available for interaction content 306a in addition to content 314a (i.e., active content 304).

Referring back to FIG. 1, in some implementations, the smart contract may be configured to generate and execute a third set of instructions to record any changes to the narrative made by the users (via their user inputs) on decentralized ledger 138. For example, a change to the narrative may include destruction of a bridge. The destruction may be recorded on decentralized ledger 138. Thus, other users may access the destruction during their progression through the narrative given they have not reached those the bridge yet or during re-access of the narrative and reaching the bridge.

In some implementations, the smart contract may be configured to determine whether one of the checkpoints is met in the narrative based on the reclassifications of the inactive content to the active content and the user inputs. Meeting one of the checkpoints may refer to a given user, any user, or a particular amount of users progressing through the narrative up to the checkpoint. Progressing through the narrative may include reading the narrative, progressing through the narrative in the virtual setting (e.g., via the character), listening to the narrative, and/or other progression.

In some implementations, the smart contract may be configured to export the narrative between the checkpoint and a previous checkpoint as a segment entity. The segment entity may include the narrative between the checkpoint and the previous checkpoint. In some implementations, the smart contract may be configured to export the narrative in its entirety up to the checkpoint as the segment entity.

For example, the segment entity exported may include the destruction of the bridge. A subsequent fixing of the destruction by another user, for example, upon the other user providing user inputs to do so may be recorded to decentralized ledger 138 at a later time and may be included in a different segment entity at a subsequent export.

The smart contract may be configured to store the segment entity in electronic storage 116, decentralized ledger 138, and/or other electronic storage. The smart contract may be configured to mint a digital asset and correlate the digital asset with the segment entity. In some implementations, upon the minting of the digital asset, ownership of the digital asset may be recorded on decentralized ledger 138 as held by the given user that met the checkpoint. Thus, segment entities exported may be a virtual memorial of a portion of the narrative for the given user.

In some implementations, digital wallets associated with the users may include addresses that are tracked on decentralized ledger 138. The digital wallets may hold tokens or a specialized currency expendable to provide the user inputs, the digital assets, and/or other assets. That is, the users may be required to spend one or more of the tokens to provide the user inputs that may contribute to the uncovering the inactive content. In some implementations, the specialized currency, herein after referred to as “tokens”, may be specific to the narrative and fungible. As such, the specialized tokens may only be expendable to provide the user inputs for that narrative. In some implementations, the tokens may be specific to a particular author, publisher, game platform, and/or other provider of narratives. As such, the tokens may be expended to provide the user inputs for multiple narratives and not be restricted to a single narrative. In some implementations, the tokens may be received upon purchasing or otherwise accessing the narrative. In some implementations, a specific amount of tokens may be received upon the initial access to the narrative. In some implementations, the tokens may be purchased via external resources 114.

In some implementations, the smart contract may be configured to receive an amount of the tokens used by the users to provide the user inputs. In some implementations, providing different ones of the user inputs may require a different amount of the tokens. In some implementations, providing some of the user inputs may not require expending the tokens. In some implementations, the smart contract may be configured to determine ownership portions of the digital asset based on the amount of the tokens used by or expended by each of the users. Determination of the ownership portions may be responsive to the checkpoint being met by the particular amount of users or any user.

Thus, for example, upon a first user using more of their tokens to provide their user input than a second user, a first ownership portion of the digital asset for the first user may be larger than a second ownership portion of the digital asset for the second user. The smart contract may be configured to generate and execute a second set of instructions to record the ownership portions in associated with the users on decentralized ledger 138. As such, the respective digital wallets associated with the users may hold at least a portion of the digital asset. Thus, the segment entity may represent the narrative, or part thereof, and what the respective users have contributed to the narrative.

As used herein, the word “mint” may refer to performance, initiating, and/or execution of the process(es), transaction(s), procedure(s), operation(s), and/or step(s) that result in the instantiation of a given digital asset, including the establishment of ownership, and definition of appearance associated with the given digital asset. Minting the given digital asset may include generating the given digital asset record for a given entity, such as the segment entity or other entities. In some implementations, minting the given digital asset may include building an executable program. The executable program to be transmitted to a distributed computing platform(s) capable of executing the program. In some implementations, execution of the program by the distributed computing platform may display the entity correlated to the given digital asset on the distributed platforms. In some implementations, the given digital asset record may include values or other information that define the correlated entity. In some implementations, the given digital asset record may be recorded at a given address on decentralized ledger(s) in a smart contract and/or other executable code. The given digital asset record may include information pertaining to the minted given digital asset, not limited to what defines the correlated entity.

As used herein, the term “digital asset” may refer to a unique identifier tracked on one or more permanent registries. The digital assets may be uniquely identified and/or uniquely identifiable. The unique identifier may include a set of numbers and/or alphabetic characters. As used herein, rights pertaining to digital assets may be tracked, recorded, and/or otherwise registered on one or more permanent registries. As such, an individual digital asset may be a registry-tracked digital asset.

Individual digital assets may be associated and/or correlated with another entity (which may be referred to as a “correlated entity”) by virtue of technology provided and/or supported by the one or more permanent registries on which the rights pertaining to the individual digital assets is tracked (including but not limited to smart contracts and/or other executable code on the one or more permanent registries). Accordingly, rights pertaining to a digital asset may correlate to the provision of one or more rights with respect to the correlated entity (e.g., control of the correlated entity and/or accessibility to the correlated entity). Transactions involving a digital asset recorded on a permanent registry may correlate to certain transactions (or modifications) of the correlated entity, and/or vice versa.

Various types and/or combinations of correlated entities are envisioned within the scope of this disclosure, including but not limited to physical article, virtual objects, content, narratives, rights, memberships, grants, etc. The use of the singular “entity” or “correlated entity” is not intended to be limiting, as multiple different objects, content, narratives, rights, memberships, grants, etc. may be correlated to a single digital asset. By way of non-limiting example, a correlated entity may be a physical article (e.g., artwork, a ticket to an event), a subscription to certain media content, content that comprises the narrative and so forth. The content may include the active content such as an image, a video, a graphic image file, a signature of notoriety, a sound bite of an audio file, the audio file, text, and/or other content stored on the permanent registry and/or other electronic storage. In some implementations, the correlated entity may refer to any physical articles, virtual objects, content, rights, memberships, grants, etc. related to art and entertainment for which a user may use, own, sell, trade, loan, destroy, and/or otherwise effectuate a change of ownership, access, or control (including exchanges through challenges).

A digital asset may be fungible if it is functionally and/or physically indistinguishable from another digital asset. A digital asset may be non-fungible if it is unique, or one-of-a-kind. For example, a specific individual may be non-fungible. A digital asset may be semi-fungible if there is a set of a limited number of similar but distinguishable digital assets. For example, a limited amount of images of a sports team for a particular year may be semi-fungible. For example, a digital ticket to a show, concert, exhibition, and/or other events may be semi-fungible. The semi-fungible digital assets are considered as unique, “not fungible”, or non-fungible digital assets. In some implementations, the digital assets may include non-fungible tokens, fungible tokens, semi-fungible tokens, and/or other digital assets.

In some implementations, permanent registries, or decentralized ledger(s) 138, may be implemented by registry servers or decentralized ledger server(s) 122. The terms “permanent registries” and “decentralized ledgers” may be used interchangeably herein. The terms “registry servers” and “decentralized database servers” may be used interchangeably herein. In some implementations, one or more permanent registries may be decentralized and/or immutable registries. In some implementations, the one or more permanent registries may be one or more databases on which the rights pertaining to the individual digital assets are tracked and/or recorded. In some implementations, blockchains may be maintained by distributed computing platforms (not shown in FIG. 1). In some implementations, a distributed computing platform may be implemented by a set of client computing platform(s) 104 and/or servers (including, for example, one or more registry servers). The distributed computing platform may support a virtual machine (not shown in FIG. 1). The distributed computing platform and/or the virtual machine may form a runtime environment for smart contracts and/or other executable code. A distributed computing platform may include electronic storage configured to store part or all of individual blockchains. For example, the smart contracts may be stored on one or more blockchains, and/or another permanent registry. In some implementations, the distributed computing platform may be the EOSIO platform. In some implementations, the distributed computing platform may be similar to or based on the EOSIO platform. In some implementations, the distributed computing platform may be Ethereum. In some implementations, the distributed computing platform may be similar to or based on Ethereum. In some implementations, the virtual machine may be a distributed and/or decentralized virtual machine.

In some implementations, at least one of the permanent registries may be a private permissioned permanent registry (e.g., a private permissioned blockchain). The private permissioned permanent registry may be configured to record information and/or track addresses (e.g., corresponding to digital wallets, smart contracts, etc.). The recorded information may include rights pertaining to the digital assets. For example, ownership rights and/or other accessibility may be modified. In some implementations, the ownership rights and/or other rights may be indicated by addresses tracked and recorded by the permanent registries on the registry servers that correspond to digital wallets of users and transaction information recorded on the permanent registry. In some implementations, a digital asset may be removed from one permanent registry and added or recorded on another permanent registry. In some implementations, at least one of the permanent registries implemented by the registry servers is a public permanent registry (e.g., a public blockchain). The public permanent registry may be configured to be part of either EOSIO mainnet, Ethereum mainnet, Ethereum 1.5, Ethereum 2.0, a derivative of Ethereum 2.0 that is configured to perform transactions of Ether (ETH) between accounts, or a derivative of EOSIO that is configured to perform transactions of EOS between different accounts.

Elements of a blockchain or another permanent registry may be grouped together in units that are referred to as blocks. For example, an individual block may include one or more digital assets and one or more transactions. For example, an individual block may be linked to one or more other individual blocks. Individual blocks may be linked or chained together to form a structure of blocks and/or a hierarchy of blocks, such as, e.g., a chain of blocks. An individual block may include one or more digital assets, one or more transactions, smart contracts, and/or other information.

In some implementations, one or more permanent registries implemented by the registry servers may be publicly accessible. In some implementations, for example, the one or more databases may be accessible via a mobile application or a website. In some implementations, one or more permanent registries implemented by the registry servers may be private and/or permissioned. In some implementations, one or more permanent registries implemented by the registry servers may be append-only. In some implementations, existing blocks of one or more permanent registries implemented by the registry servers can substantially not be altered or deleted, unless multiple copies are altered. This is unlikely to happen provided that the multiple copies are stored on different computing platforms, e.g., in different geographical locations. Permanent registries may be replicated on multiple computing platforms, preferably in multiple different geographical locations. Additionally, individual blocks may be linked together in a manner that prevents tampering, such as, e.g., using a hash chain and/or digital signatures. In particular, hash values may be generated using fixed-output-length one-way hashing functions that take variable-length input, and may be effectively impossible (or, at least, computationally infeasible) to reverse. As such, a hashing function may provide one-way encryption. By way of non-limiting example, the hashing function may be SHA-256, BLAKE2, SHAKE256, and/or another hashing function. Contents of individual blocks, transactions, and/or articles may be digitally signed in a manner that proves integrity and/or prevents tampering, e.g., by providing authentication, as well as non-repudiation.

The decentralized ledger server(s) 122 may include one or more of processor(s) 140, machine-readable instructions 132, decentralized ledger(s) 138, electronic storage (not illustrated), and/or other components. The electronic storage may be similar to electronic storage 116 as described elsewhere in this disclosure, though included in the decentralized ledger server(s) 122. Machine-readable instructions 132 may include one or more instruction components. The instruction components may include computer program components. The instruction components may include one or more of an instruction receiving component 134, a record component 136, and/or other instruction components. Processor(s) 140 may be similar to processor(s) 118 as described elsewhere in this disclosure, though included in the decentralized ledger server(s) 122. Machine-readable instructions 132 may be similar to machine-readable instructions 106 as described elsewhere in this disclosure, though included in decentralized ledger server(s) 122.

Instruction receiving component 134 may be configured to receive (sets of) instructions to add, modify, analyze, and/or remove recorded information (e.g., rights) in the decentralized ledger(s) 138. For example, instruction receiving component 134 may receive one or more sets of instructions from other components of system 100. Instruction receiving component 134 may provide received sets of instructions to the record component for execution. In some implementations, instruction receiving component 134 may be arranged, organized, and/or otherwise included in the decentralized ledger server(s) 122 and/or the decentralized ledger(s) 138.

Record component 136 may be configured to record information, including but not limited to ownership rights pertaining to the digital assets correlated with entitles, e.g., on one or more permanent ledgers such as the decentralized ledger(s) 138. In some implementations, record component 136 may add, modify, analyze, and/or remove recorded information.

In some implementations, server(s) 102, client computing platform(s) 104, and/or external resources 114 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 114 may be operatively linked via some other communication media.

A given client computing platform 104 may include one or more processors configured to execute computer program components. The computer program components may be configured to enable an expert or user associated with the given client computing platform 104 to interface with system 100 and/or external resources 114, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 114 may include sources of information outside of system 100, external entities participating with system 100, and/or other resources. In some implementations, some or all of the functionality attributed herein to external resources 114 may be provided by resources included in system 100.

Server(s) 102 may include electronic storage 116, one or more processors 118, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 116 may comprise non-transitory storage media that electronically stores information. The electronic storage media of electronic storage 116 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 116 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 116 may include one or more virtual storage resources (e.g., cloud storage, a virtual private network, and/or other virtual storage resources). Electronic storage 116 may store software algorithms, information determined by processor(s) 118, information received from server(s) 102, information received from client computing platform(s) 104, and/or other information that enables server(s) 102 to function as described herein.

Processor(s) 118 may be configured to provide information processing capabilities in server(s) 102. As such, processor(s) 118 may include one or more of a digital processor, an analog processor, a digital circuit designed to process information, an analog circuit designed to process information, a state machine, and/or other mechanisms for electronically processing information. Although processor(s) 118 is shown in FIG. 1 as a single entity, this is for illustrative purposes only. In some implementations, processor(s) 118 may include a plurality of processing units. These processing units may be physically located within the same device, or processor(s) 118 may represent processing functionality of a plurality of devices operating in coordination. Processor(s) 118 may be configured to execute components 108, 110, and/or 112, and/or other components. Processor(s) 140 may be configured to execute components 134 and/or 136, and/or other components. Processor(s) 140 may be configured to execute components 134 and/or 136, and/or other components. Processor(s) 118 may be configured to execute components 108, 110, and/or 112, and/or other components and processor(s) 140 may be configured to execute components 134 and/or 136, and/or other components by software; hardware; firmware; some combination of software, hardware, and/or firmware; and/or other mechanisms for configuring processing capabilities on processor(s) 118 and processor(s) 140, respectively. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 and components 134 and/or 136 are illustrated in FIG. 1 as being implemented within single separate processing units, in implementations in which processor(s) 118 and processor(s) 140 include multiple processing units, one or more of components 108, 110, and/or 112 may be implemented remotely from the other components and components 134 and/or 136 may be implemented remotely from the other components, respectively.

The description of the functionality provided by the different components 108, 110, 112, 134, and/or 136 described below is for illustrative purposes, and is not intended to be limiting, as any of components 108, 110, 112, 134, and/or 136 may provide more or less functionality than is described. For example, one or more of components 108, 110, 112, 134, and/or 136 may be eliminated, and some or all of its functionality may be provided by other ones of components 108, 110, 112, 134, and/or 136. As another example, processor(s) 118 and processor(s) 140 may be configured to execute one or more additional components that may perform some or all of the functionality attributed below to one of components 108, 110, 112, and one of components 134 and/or 136, respectively.

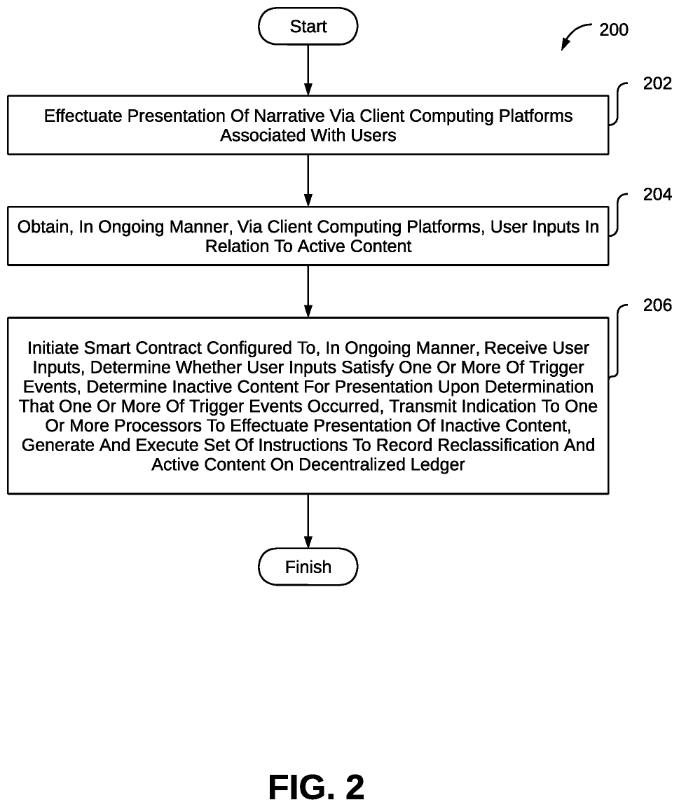

FIG. 2 illustrates a method 200 to determine content for a narrative based on user input related to the narrative, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include effectuating presentation of a narrative via client computing platforms associated with users. The narrative may be stored in electronic storage. The narrative may include content that is classified as active content and inactive content. The active content may be presented and available as the narrative progresses, wherein the inactive content is available within the narrative upon trigger events associated with the inactive content occurring. The active content within the narrative may be recorded on a decentralized ledger. Operation 202 may be performed by one or more hardware processors configured by machine-readable instructions including a component that is the same as or similar to presentation effectuation component 108, in accordance with one or more implementations.

An operation 204 may include obtaining, in an ongoing manner, via the client computing platforms, user inputs in relation to the active content. Operation 204 may be performed by one or more hardware processors configured by machine-readable instructions including a component that is the same as or similar to user input obtaining component 110, in accordance with one or more implementations.

An operation 206 may include initiating a smart contract configured to, in an ongoing manner, receive the user inputs, determine whether user inputs satisfy one or more of trigger events, determine inactive content for presentation upon determination that one or more of trigger events occurred, transmit indication to one or more processors to effectuate presentation of inactive content, generate and execute set of instructions to record reclassification and active content on decentralized ledger, and/or other functionalities. Operation 206 may be performed by one or more hardware processors configured by machine-readable instructions including a component that is the same as or similar to contract initiation component 112, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to determine content for a narrative based on user input related to the narrative, the system comprising:
electronic storage configured to store a narrative, wherein the narrative includes content that is classified as active content or inactive content, wherein the active content is presented and available as the narrative progresses, wherein the inactive content is available within the narrative upon trigger events associated with the inactive content occurring, wherein the active content within the narrative is recorded on a decentralized ledger;
one or more processors configured by machine-readable instructions to:
effectuate presentation of the narrative via client computing platforms associated with users;
obtain, in an ongoing manner, via the client computing platforms, user inputs in relation to the active content; and
initiate a smart contract configured to, in an ongoing manner:
receive the user inputs;
determine whether the user inputs satisfy one or more of the trigger events;
determine the inactive content for presentation upon determination that one or more of the trigger events occurred;
transmit an indication to the one or more processors to effectuate presentation of the inactive content, wherein effectuating presentation of the inactive content reclassifies the inactive content as the active content; and
generate and execute a set of instructions to record the reclassification and the active content on the decentralized ledger.

2. The system of claim 1, wherein the content includes tiers for the inactive content, wherein the tiers include a first tier, a second tier, and a third tier as an order of accessibility of the inactive content by way of the trigger events associated with the inactive content.

3. The system of claim 2, wherein some of the trigger events require a user interaction or user answer as the user inputs in the first tier, wherein some of the trigger events require multiple ones of the user inputs in the second tier, wherein some of the trigger events require multiple and particular ones of the user inputs in the third tier.

4. The system of claim 1, wherein the narrative includes checkpoints, wherein the active content progresses towards the checkpoints.

5. The system of claim 4, wherein the smart contract is configured to:
determine whether one of the checkpoints is met in the narrative based on the reclassifications of the inactive content to the active content and the user inputs;
export the narrative between a checkpoint and a previous checkpoint as a segment entity;
store the segment entity in the electronic storage; and
mint a digital asset that is correlated with the segment entity.

6. The system of claim 5, wherein digital wallets associated with the users include addresses that are tracked on the decentralized ledger, wherein the digital wallets hold tokens expendable to provide the user inputs, wherein the smart contract is configured to:
receive an amount of the tokens used by the users to provide the user inputs;
determine ownership portions of the digital asset based on the amount of the tokens used by each of the users; and
generate and execute a second set of instructions to record the ownership portions in associated with the users on the decentralized ledger.

7. A method to determine content for a narrative based on user input related to the narrative, the method comprising:
effectuating presentation of the narrative via client computing platforms associated with users;
obtain, in an ongoing manner, via the client computing platforms, user inputs in relation to active content, wherein the active content is stored in electronic storage, wherein the electronic storage further stores a narrative, wherein the narrative includes content that is classified as the active content or inactive content, wherein the active content is presented and available as the narrative progresses, wherein the inactive content is available within the narrative upon trigger events associated with the inactive content occurring, wherein the active content within the narrative is recorded on a decentralized ledger;
initiating a smart contract configured to, in an ongoing manner:
receiving the user inputs;
determining whether the user inputs satisfy one or more of the trigger events;
determining the inactive content for presentation upon determination that one or more of the trigger events occurred;
transmitting an indication to the one or more processors to effectuate presentation of the inactive content, wherein effectuating presentation of the inactive content reclassifies the inactive content as the active content; and
generating and executing a set of instructions to record the reclassification and the active content on the decentralized ledger.

8. The method of claim 7, wherein the content includes tiers for the inactive content, wherein the tiers include a first tier, a second tier, and a third tier as an order of accessibility of the inactive content by way of the trigger events associated with the inactive content.

9. The method of claim 8, wherein some of the trigger events require a user interaction or user answer as the user inputs in the first tier, wherein some of the trigger events require multiple ones of the user inputs in the second tier, wherein some of the trigger events require multiple and particular ones of the user inputs in the third tier.

10. The method of claim 7, wherein the narrative includes checkpoints, wherein the active content progresses towards the checkpoints.

11. The method of claim 10, further comprising:
determining whether one of the checkpoints is met in the narrative based on the reclassifications of the inactive content to the active content and the user inputs;
exporting the narrative between a checkpoint and a previous checkpoint as a segment entity;
storing the segment entity in the electronic storage; and
minting a digital asset that is correlated with the segment entity.

12. The method of claim 11, wherein digital wallets associated with the users include addresses that are tracked on the decentralized ledger, wherein the digital wallets hold tokens expendable to provide the user inputs, further comprising:
receiving an amount of the tokens used by the users to provide the user inputs;
determining ownership portions of the digital asset based on the amount of the tokens used by each of the users; and
generating and execute a second set of instructions to record the ownership portions in associated with the users on the decentralized ledger.
